(19) United States
(12) Patent Application Publication
(10) Pub. No.: US 2013/0174187 A1
(43) Pub. Date: Jul. 4, 2013

(54) SYSTEMS AND METHODS FOR RECOMMENDING MEDIA ASSETS IN A MEDIA GUIDANCE APPLICATION

(71) Applicant: Ben Tan, Palo Alto, CA (US)

(72) Inventor: Ben Tan, Palo Alto, CA (US)

(73) Assignee: UNITED VIDEO PROPERTIES, INC., Santa Clara, CA (US)

(21) Appl. No.: 13/339,882

(22) Filed: Dec. 29, 2011

(51) Int. Cl. H04N 21/462; H04N 21/258

(52) U.S. Cl. 725/10

(57) ABSTRACT

Systems and methods for recommending media assets in a media guidance application are provided. One or more signals indicative of motion of a user input device may be received. In response to receiving one or more signals indicative of motion of the user input device, a region containing media identifiers may be animated, where the animated region may be used to randomly select a media identifier for presentation to the user.

### BACKGROUND OF THE INVENTION

Due to the overwhelming volume of media content (e.g., television shows) available to the average person (e.g., via cable or satellite television), interactive media guidance applications, such as interactive program guides, have gained widespread popularity. Typically, these guidance applications present guide listings in a two-dimensional grid indexed by time and source (e.g., a television channel). Even with these interactive media guidance applications, it is often difficult for viewers to decide what to watch, which may result in endlessly changing channels until discovering something interesting to watch.

Moreover, with recent advancements in communications network technologies, viewers can navigate through program listings in an interactive program guide using various devices, such as mobile devices, tablet computers, and other media equipment devices. However, viewers using these devices may have limited navigational equipment, such as a small screen, a keypad, and/or a pointing device. It may be even more difficult to search for a program to watch on one of these devices.

### SUMMARY OF THE INVENTION

In view of the foregoing, systems and methods for recommending media assets in a media guidance application are provided. In particular, the media guidance application may monitor user signals indicative of motion of a user input device. The user input device may be, for example, a remote control, a mobile device, a tablet computing device, the device executing or displaying the media guidance application, or any other suitable device having a sensor for receiving and/or transmitting user signals. In response to receiving signals indicative of motion of the user input device, the media guidance application may provide one or more animations that randomly select a media identifier corresponding to a media asset from a plurality of media identifiers.

In some embodiments, a user request to display a plurality of program listings is received. In particular, a user may select a listings icon from a program listings display to instruct control circuitry to retrieve program listings. The control circuitry may, in response to receiving the request, present a display that includes a first subset of media identifiers. A media identifier may be, for example, a program title, a genre, a rating, a media type, or any other suitable identifier associated with a program or any other suitable media asset.

In some implementations, the media identifiers may be retrieved based on the location of the user equipment (e.g., a global positioning satellite (GPS) signal from a mobile device). Alternatively or additionally, the media identifiers may be retrieved based on a user inputted location (e.g., an inputted zip code, an inputted service type, an inputted service provider, an inputted time zone, etc.). For example, in response to the user inputting a zip code, the media guidance application may retrieve media identifiers associated with one or more service providers associated with the inputted zip code.

In some embodiments, the media guidance application may receive one or more signals indicative of motion of a user input device of the user. For example, the media guidance application may detect signals obtained by a user sensor, such as an accelerometer in the user input device. In another example, the accelerometer in the user input device may transmit motion information to the media guidance application, where the motion information may include an indication of accelerations above a particular threshold magnitude, an indication of accelerations with energy in particular frequency bands that indicate a user shaking the user input device, and/or an indication of accelerations with a high amplitude frequency component that indicate the user is tapping on the user input device.

In response to receiving these signals indicative of motion of the user input device of the user, the media guidance application may animate a region containing at least a portion of the first subset of media identifiers. The animated region may be, for example, a graphical representation of a slot machine having a plurality of rotatable drums, where one or more of the first subset of media identifiers are placed on each of the rotatable drums. In some embodiments, the media guidance application may provide an animation that shuffles the first subset of the media identifiers within a listings display.

Upon providing the animation, the media guidance application may then randomly select a media identifier for presentation to the user. It should be noted that the random selection by the media guidance application may include a random selection from a plurality of media identifiers, a pseudo-random selection from the plurality of media identifiers, a selection based on user profile information, a selection based on location information, etc.

In response to presenting the user with the media identifier, the user may provide an indication to access the media asset corresponding to the media identifier. In some embodiments, the media guidance application may continue to monitor for signals indicative of motion of the user input device of the user (e.g., a subsequent shaking of the user input device) to present another animation.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative displays screen that may be used to provide media guidance application listings in accordance with some embodiments of the invention;

FIG. 3 shows an illustrative user equipment device in accordance with some embodiments of the invention;

FIG. 4 is a diagram of an illustrative cross-platform interactive media system in accordance with some embodiments of the invention;

FIG. 5 shows an illustrative display of a user location prompt in accordance with some embodiments of the invention;

FIG. 6 shows an illustrative display of a slot machine animation for presenting a media guidance application listing in accordance with some embodiments of the invention;

FIG. 7 shows an illustrative display of the slot machine animation with rotatable drums that each have a category relating to media guidance application listings in accordance with some embodiments of the invention;

FIG. 8 shows an illustrative display of the slot machine animation selecting a media guidance application listing in accordance with some embodiments of the invention;

FIG. 9 shows an illustrative display of the slot machine animation with selectable media parameters in accordance with some embodiments of the invention;

FIG. 10 shows an illustrative display of the slot machine, where media guidance application listings are filtered based on selected media parameters, in accordance with some embodiments of the invention;

FIG. 11 shows an illustrative display of an altered listings display that shuffles media guidance application listings in accordance with some embodiments of the invention;

FIGS. 12 and 13 show illustrative displays that provide media guidance application listings and provide an animation using regions of the displays to provide a user with a media guidance application listing in accordance with some embodiments of the invention;

FIG. 14 illustrates a flow diagram for animating a region containing media guidance application listings in response to receiving signals indicative of motion of a user input device in accordance with some embodiments of the invention; and

FIG. 15 shows an illustrative example of a file in Extensible Markup Language (XML) for retrieving and displaying one or more animations for selecting a media identifier in accordance with some embodiments of the invention.

### DETAILED DESCRIPTION OF EMBODIMENTS

This invention generally relates to systems and methods for recommending media assets in a media guidance application. In particular, systems and methods are provided for providing one or more animations to a user that randomly select a media guidance application listing in response to receiving signals indicative of motion of a user input device.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

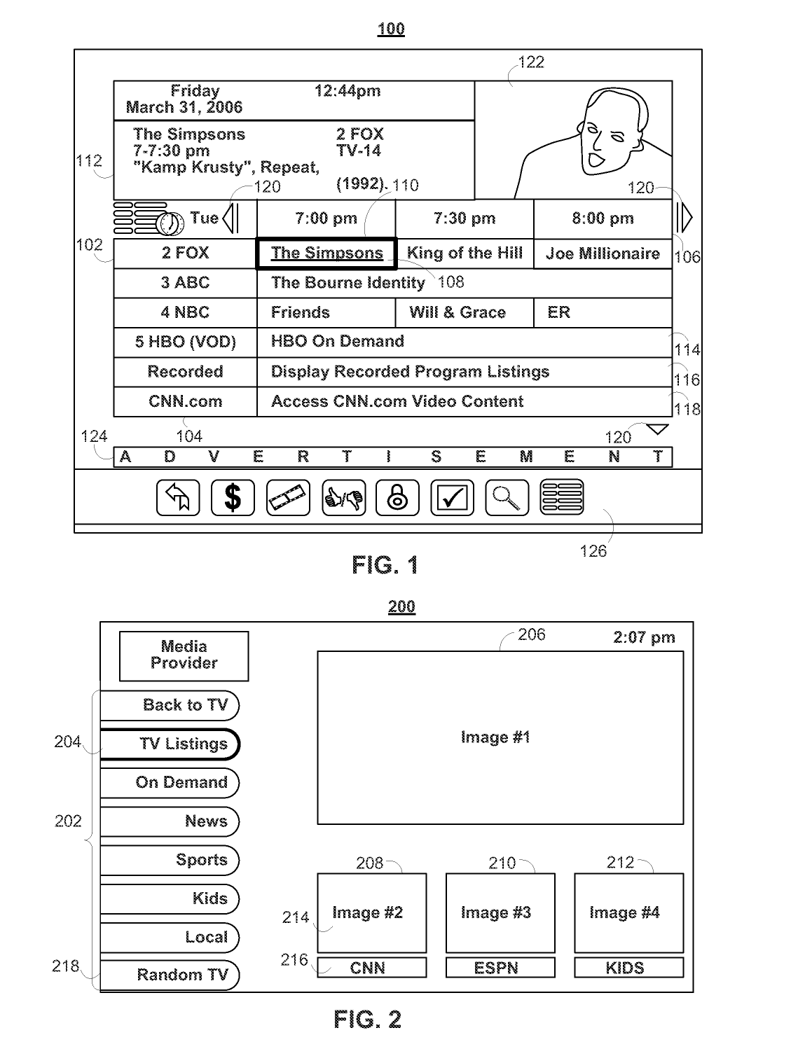

FIGS. 1-2 show illustrative display screens that may be used to provide media guidance data. The display screens shown in FIGS. 1-2 and 5-13 may be implemented on any suitable user equipment device or platform. While the displays of FIGS. 1-2 and 5-13 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

In some embodiments, the user may navigate through media guidance application listings, such as the program listings shown in FIG. 1. The user may request that the media guidance application recommend a program by positioning highlight region 110 over a random selection option and pressing a suitable key on a remote control (e.g., a select key). Alternatively, when the media guidance application is executed on a wireless communications device with a touch screen, the user may make contact with the touch screen using any suitable object or appendage, such as a stylus, finger, etc. For example, instead of pressing a suitable key on the remote control, the media guidance application may respond to contact with a touch screen, such as one or more taps on the touch screen, maintaining continuous contact with the touch screen, movement of the point of contact while maintaining continuous contact, a breaking of the contact, or any combination thereof.

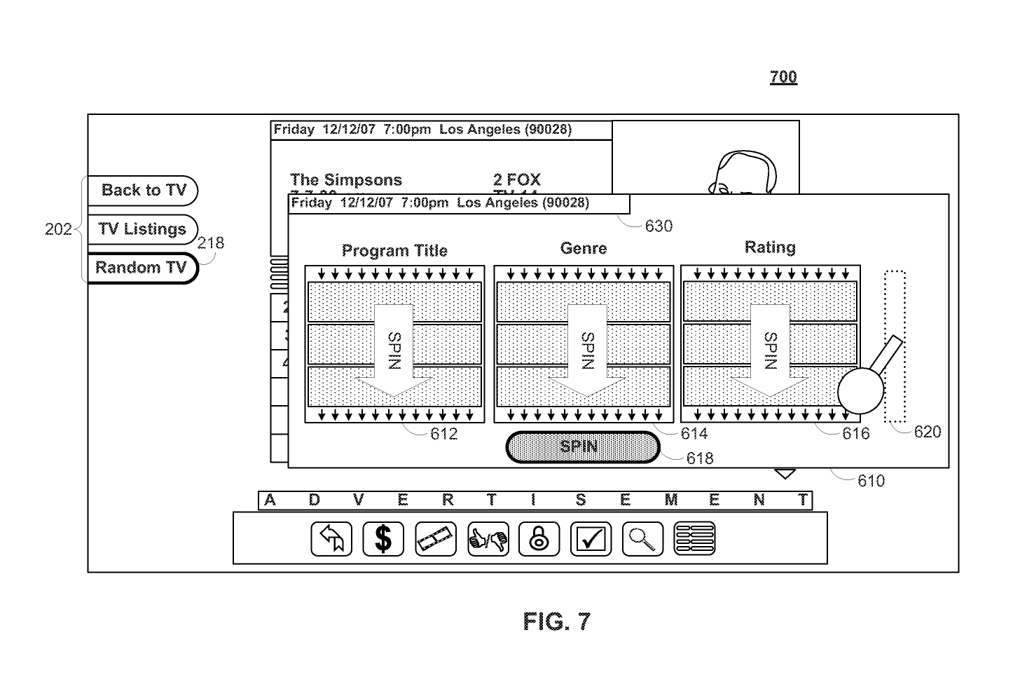

In some embodiments, the media guidance application may provide the user with one or more images for selecting a program. For example, as shown in FIGS. 6-10, the media guidance application may provide the user with an image of a slot machine, where multiple media identifiers are placed on the rotatable drums of the slot machine. The image of the slot machine may be the initial image of a sequence of images in an animation file.

In some embodiments, the media guidance application may monitor a user input device for signals indicative of motion. The user input device may be, for example, a remote control or any other suitable user input interface having an accelerometer, a wireless user communications device having an accelerometer that is connected to the user equipment executing the media guidance application, or the user equipment itself having a sensor for detecting motion and/or orientation of the user equipment.

The media guidance application may receive signals indicative of motion of a user input device. For example, the user input device may transmit particular motion information (e.g., a shaking motion, a pulling or tilting gesture, etc.) to the media guidance application. In response, the media guidance application may cause an animation to be presented to the user. The animation may animate a region containing the media identifiers. For example, in response to determining that a user is shaking the user input device, an animated slot machine may be presented, where the media identifiers are rotated on the drums of the animated slot machine.

Upon providing the animation, the media guidance application may select a media guidance application listing for presentation to the user. For example, the media guidance application may recommend that the user watch “The Simpsons” on channel 2 (FOX) that starts at 7:00 PM. Alternatively, any suitable media identifier (e.g., channel, genre, etc.) can be presented to the user. For example, after an animation shuffles through various channels available at the user's location, the media guidance application may recommend that the user tune to channel 4 (NBC). In another example, after an animation shuffles through various program titles available at the user's location, the media guidance application may recommend that the user watch the program titled “The Simpsons.” In response to selecting the program title presented within the animation, the media guidance application may display a list of channels and/or associated program information that are currently playing “The Simpsons” or locations where “The Simpsons” can be retrieved for playback.

The selection performed by the media guidance application may be a random selection from multiple media identifiers, a pseudo-random selection from multiple media identifiers, a selection from multiple media identifiers based on filtered media identifiers, a selection from multiple media identifiers based on location information, a selection from multiple media identifiers based on user history information, etc. This provides the user with an animation acting as a randomizer and assists the user in selecting a program to watch. The animation may cause program listings or other media identifiers, such as program titles, to tumble and slowly land in place providing the user with a recommended offering.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

For example, the media guidance application may retrieve portions of user profile information associated with the user for selecting a media identifier. In a more particular example, the media guidance application may determine user location information and media preferences (e.g., preferred media type, preferred channels, preferred genres of programming, etc.). In response, the media guidance application may use the information derived from the user profile information to select a media identifier for presentation with the animation.

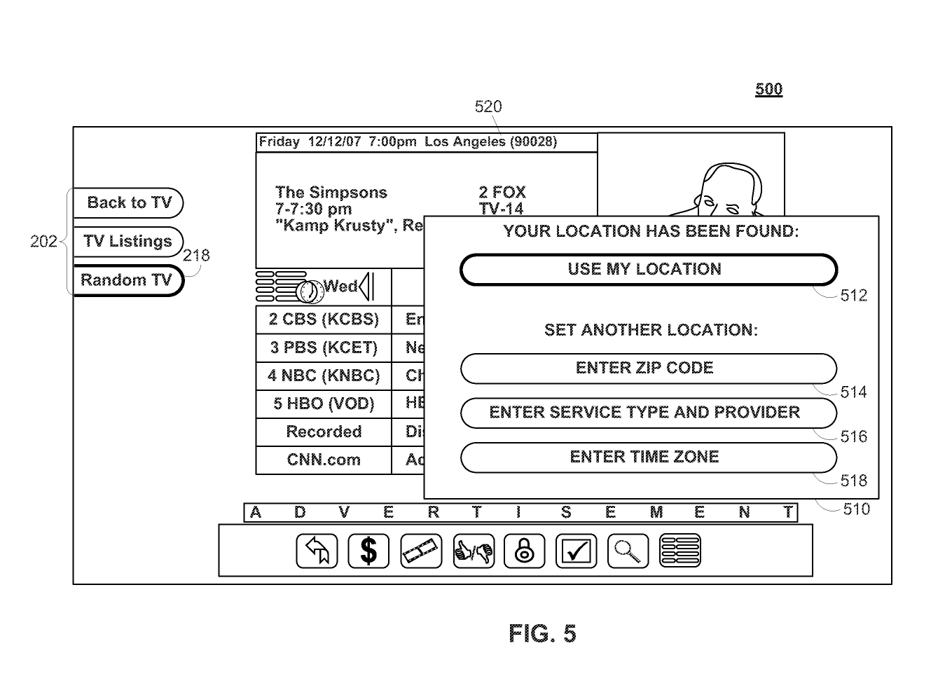

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

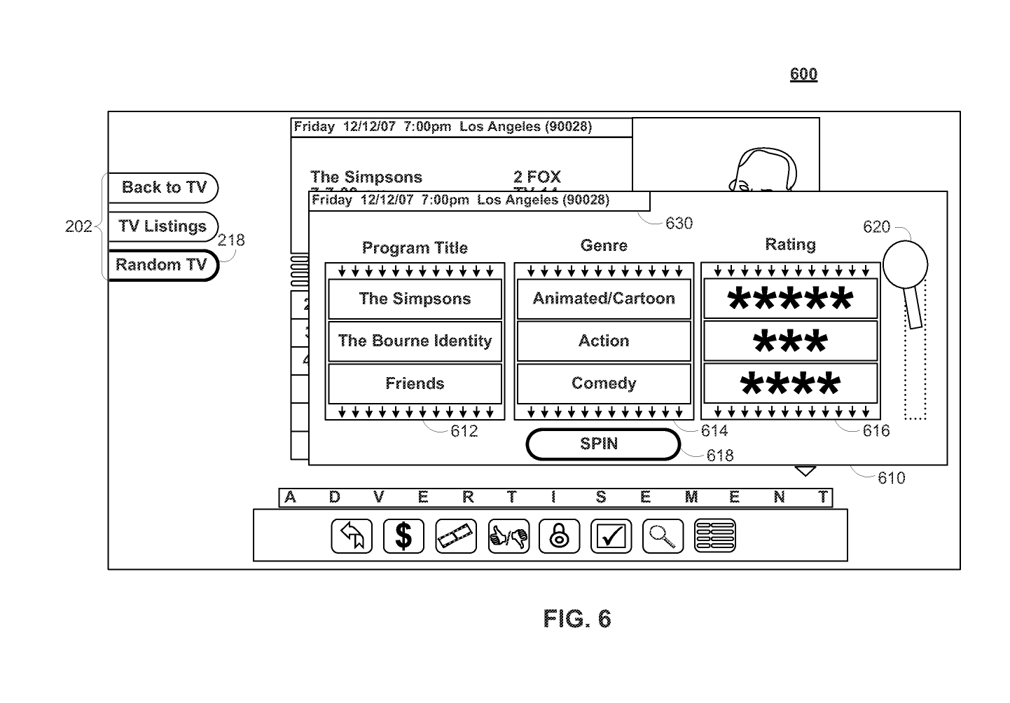

A random selection option 218 may be included that allows the user to randomly select a media guidance application listing or any other suitable media identifier. In particular, selection of random selection option 218 may navigate the user to user location information screen 500 (FIG. 5) or to one of the animation display screens shown in FIGS. 6-13. The user may also instruct the media guidance application to filter the media guidance application listings or other media identifiers based on defined media parameters (e.g., a particular genre, a particular timeslot, a particular rating, etc.).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

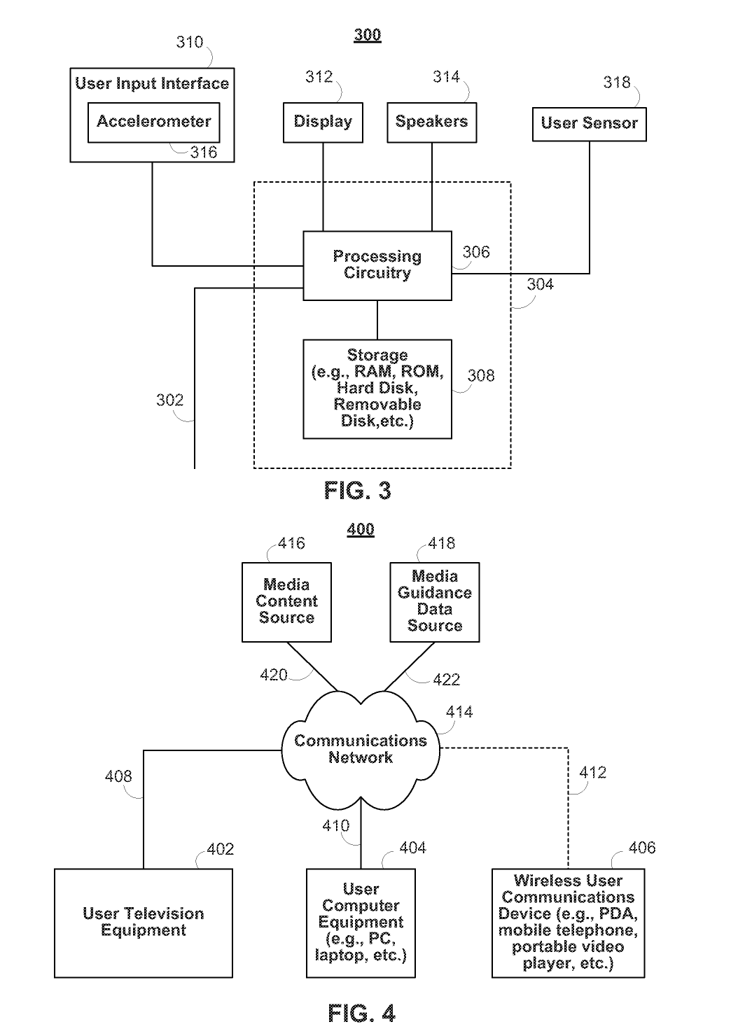

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308).

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces.

In some embodiments, user input interface 310 may contain an accelerometer or any other suitable component capable of detecting user motion. For example, when the user moves user input interface 310 containing the accelerometer, the accelerometer may transmit motion information and/or orientation information relating to the user input interface to control circuitry 304 in user equipment device 300.

It should be noted that, in some embodiments, user input interface 310 may include a gyroscope (not shown) in addition to or instead of accelerometer 316.

It should also be noted that, in some embodiments, user input interface 310 may detect particular gestures performed by the user. For example, in response to a user holding user input interface 310 containing accelerometer 316 in one hand and performing a downward motion (e.g., pulling a handle on a slot machine), user input interface 310 containing accelerometer 316 may transmit the detected gesture to control circuitry 304. In response, control circuitry 304 may activate the slot machine animation in the media guidance application and present the user with a recommended media identifier. In another example, user input interface 310 containing accelerometer 316 may transmit information indicating that the user is shaking user input interface 310 to control circuitry 304 and, in response to receiving the motion information, control circuitry 304 may activate a suitable animation in the media guidance application. In yet another example, control circuitry 304 may select an animation from multiple animations based on the received motion information (e.g., a shaking gesture as opposed to a pulling gesture).

Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

In some embodiments, a user sensor 318 may be integrated with other elements of user equipment device 300. User sensor 318 within user equipment device 300 may be, for example, an accelerometer component within a mobile device or a tablet computing device. Similar to accelerometer 316 within user input interface 310, user sensor 318 may transmit motion and/or orientation signals to control circuitry 304.

In some embodiments, control circuitry 304 may be configured to receive and interpret signals or motion information produced by user sensor 318 integrated with user equipment 300, accelerometer 316 within user input interface 310, any other suitable sensor, and/or any combination thereof. For example, control circuitry 304 may cause media guidance application listings to be presented by selecting a selectable option in a display screen (e.g., a listings option) or pressing a dedicated button (e.g., a GUIDE button) on a remote control or other user input interface 310.

In some embodiments, control circuitry 304 may monitor for signals indicative of motion of a user input device. The monitoring may occur, for example, in response to detecting that media guidance application listings are being displayed to the user. In another suitable example, the monitoring may occur in response to detecting that the media guidance application is providing a particular display screen, such as a program listings display, to the user.

In response to detecting or receiving one or more signals indicative of motion, control circuitry 304 may retrieve media identifiers relating to the media guidance application listings. Control circuitry 304 may populate or render an animation, such as an animation of a slot machine, with at least a subset of the media identifiers. The animation or any other suitable sequence of images may be displayed to the user and, while displaying the animation, control circuitry 304 may select a media guidance application listing for presentation to the user.

Control circuitry 304 may select the media guidance application listing based on a random selection from multiple media identifiers, a pseudo-random selection from multiple media identifiers, a selection from multiple media identifiers based on filtered media identifiers, a selection from multiple media identifiers based on location information, a selection from multiple media identifiers based on user history information, etc. For example, control circuitry 304 may use a randomizer or a random number generator where the media identifiers placed in the animation have an equal probability of being selected. In another example, control circuitry 304 may use user location information and user profile information to filter out media identifiers for selection and then use a random number generator to select from the remaining media identifiers.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing.

In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In some embodiments, control circuitry 304 may display a program listing simultaneously with a program or video of the program being watched. In particular, control circuitry 304 may allow the user to browse program listings for other programs while watching the program on the display. Control circuitry 304 may display the program listing or multiple program listings by providing a display similar to grid 102 of FIG. 1 or a mosaic display with program listings similar to display 200 of FIG. 2. While browsing through program listings, control circuitry 304 may provide the user with access to a randomizer (e.g., FIGS. 6-13) for a recommended program listing. For example, as shown in FIGS. 2 and 5-11, control circuitry 304 may provide the user with random selection option 218.

FIG. 5 shows an illustrative display 500 for inputting user location information in accordance with some embodiments of the invention. User location information may be determined by receiving information from the user, such as in response to a prompt, or using a default setting. For example, in response to receiving an indication that the user has selected random selection option 218, control circuitry 304 may generate for display prompt 510. Prompt 510 provides the user with the opportunity to input location information. As shown, prompt 510 may include a zip code option 514, a service type and/or service provider option 516, and a time zone option 518. It should be noted that the user location may be inputted by the user using any suitable geographic reference, such as, for example, an address, a city, a county, a state, a zip code, a latitude and longitude, an area code, etc.

Additionally, prompt 510 may include a current detected location option 512 that determines the location of user equipment 300 or any other device associated with user equipment 300 (e.g., wireless user communications device 406 having locating circuitry, such as a global positioning system (GPS) receiver). As also shown in FIG. 5, display 500 may determine the location of the user or user equipment 300 and display a location indicator 520. Location indicator 520 shows that the user or user equipment 300 are currently located in Los Angeles (zip code 90028). The media guidance application listings displayed in display 500 and recommended using various displays described herein may be limited to media content that can be accessed at the determined location.

Alternatively, instead of prompting the user with prompt 510 to input location information, control circuitry 304 may determine the location of user equipment 300 and provide media guidance application listings and a randomly selected media guidance application listing based on the determined location information. For example, instead of prompting the user with prompt 510 to input location information, control circuitry 304 may monitor for signals indicative of motion of the user input device and, in response to receiving such signals, control circuitry 304 may determine the location of user equipment 300 and present the user with an animation for randomly selecting a media guidance application listing.

Control circuitry 304 may display any suitable animation for selecting a media identifier from a plurality of media identifiers. For example, control circuitry 304 may provide an animation for randomly selecting a media guidance application listing from the plurality of media guidance application listings of grid listing 102 (FIG. 1). FIG. 6 shows an illustrative representation of a slot machine animation 610. Slot machine animation may include a plurality of rotatable drums 612, 614, and 616, where each of the rotatable drums has media identifiers for selecting a media guidance application listing. For example, rotatable drum 612 includes program titles, such as “The Simpsons,” “The Bourne Identity,” and “Friends,” among others, that are associated with the available media guidance application listings for a given time interval (e.g., 7:00 PM). Rotatable drum 614 includes genres, such as animated/cartoon, action, and comedy, among others, and rotatable drum 616 includes ratings associated with the available media guidance application listings.

It should be noted that, although FIG. 6 shows three rotatable drums with media identifiers of program titles, genres, and ratings, any suitable number of rotatable drums may be provided. For example, control circuitry 304 may display a slot machine animation having six rotatable drums. In another example, control circuitry 304 may allow the user to add or remove a drum of media identifiers to slot machine animation 610. In yet another example, control circuitry 304 may determine a subset of preferred media identifiers (e.g., lock media identifiers based on user history information) and generate a slot machine animation having rotatable drums for the media identifiers where a user preference was not determined.

In some embodiments, control circuitry 304 may allow the user to select from any suitable category or media parameter. For example, the user may request that the genre parameter be changed to a content type parameter (e.g., a recorded program, an on-demand program, a broadcast program, a pay-per-view program, Internet content, etc.). In response to selecting a new media parameter, control circuitry 304 may retrieve from memory the associated media identifiers corresponding to the newly selected media parameter.

In some embodiments, control circuitry 304 may provide a location identifier 630 within slot machine animation 610. Control circuitry 304 may populate slot machine animation 610 with media guidance application listings and/or media identifiers based on the location identified in location identifier 630. Alternatively, control circuitry 304 may filter media guidance application listings and/or media identifiers provided within slot machine animation 610 based on user history information (e.g., previously viewed programs, previously recorded programs, etc.).

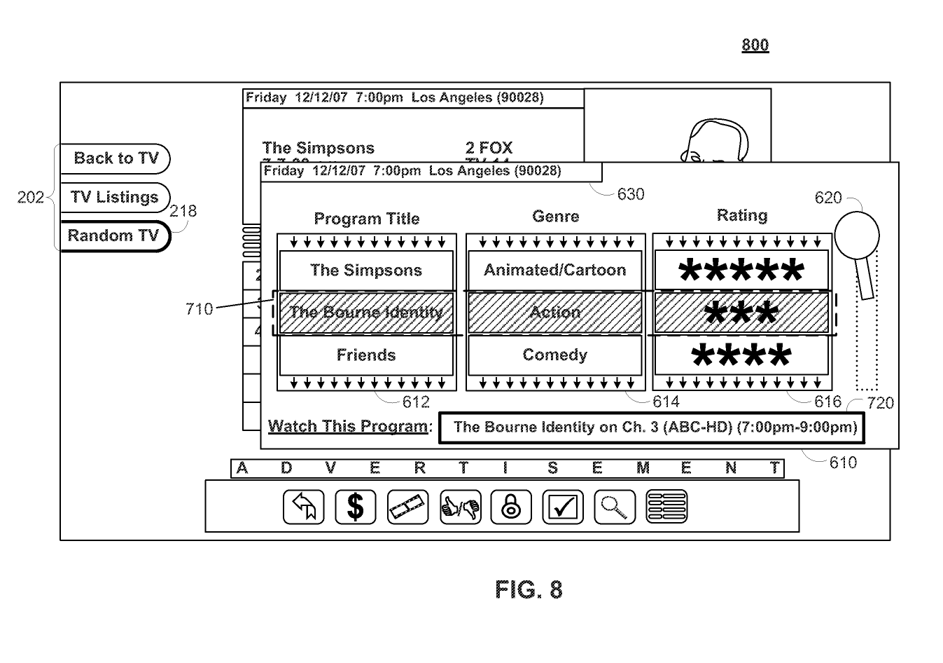

Control circuitry 304 may monitor for signals indicative of motion of the user input device and, in response to receiving such signals, control circuitry 304 may begin slot machine animation 610. For example, slot machine animation 610 may include graphical elements, such as spin button 618 and pull bar 620. As shown in FIG. 7, in response to receiving one or more signals indicative of motion of the user input device, control circuitry 610 may begin slot machine animation 610, where regions of the slot machine image are animated. For example, rotatable drums 612, 614, and 616 spin with the various media identifiers, spin button 618 lights up, and pull bar 620 is pulled downward from its initial position.

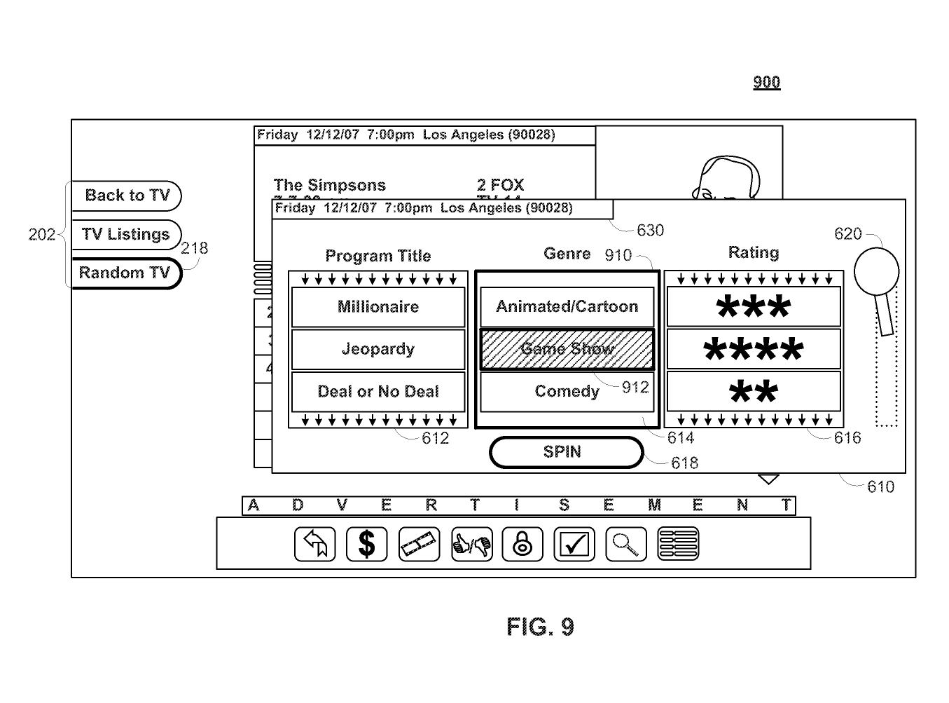

Upon providing slot machine animation 610 to the user, control circuitry 304 may randomly select a media identifier from a plurality of media identifiers. For example, as shown in FIG. 8, slot machine animation may have randomly selected one or more media identifiers and determined from the random selection which media guidance application listing from a plurality of media guidance application listings to present.

Control circuitry 304 may select the media guidance application listing based on a random selection from multiple media identifiers, a pseudo-random selection from multiple media identifiers, a selection from multiple media identifiers based on filtered media identifiers, a selection from multiple media identifiers based on location information, a selection from multiple media identifiers based on user history information, etc. For example, as shown in FIG. 8, control circuitry 304 provides highlight region 710 to indicate the media identifiers used for selecting the program “The Bourne Identity.” Additionally, control circuitry 304 may present the user with a selectable listing 720 to access the program “The Bourne Identity” on Ch. 3 (ABC-HD) that is showing from 7:00 PM-9:00 PM.

Additionally or alternatively to accessing the content corresponding to the selected listing (e.g., by tuning to the channel), control circuitry 304 may provide the user with the opportunity to set various settings, such as record the content, set a reminder to watch the content, etc. In some embodiments, control circuitry 304 may select the media guidance application listing and instruct a second screen device (e.g., wireless user communications device 406) to tune to the content, record the content, set a reminder to watch the content, etc. In some embodiments, control circuitry 304 may select the media guidance application listing on a first user equipment device and instruct control circuitry 304 to instruct the second screen device to tune to the content and simultaneously record the content in a storage device connected to the first user equipment device.

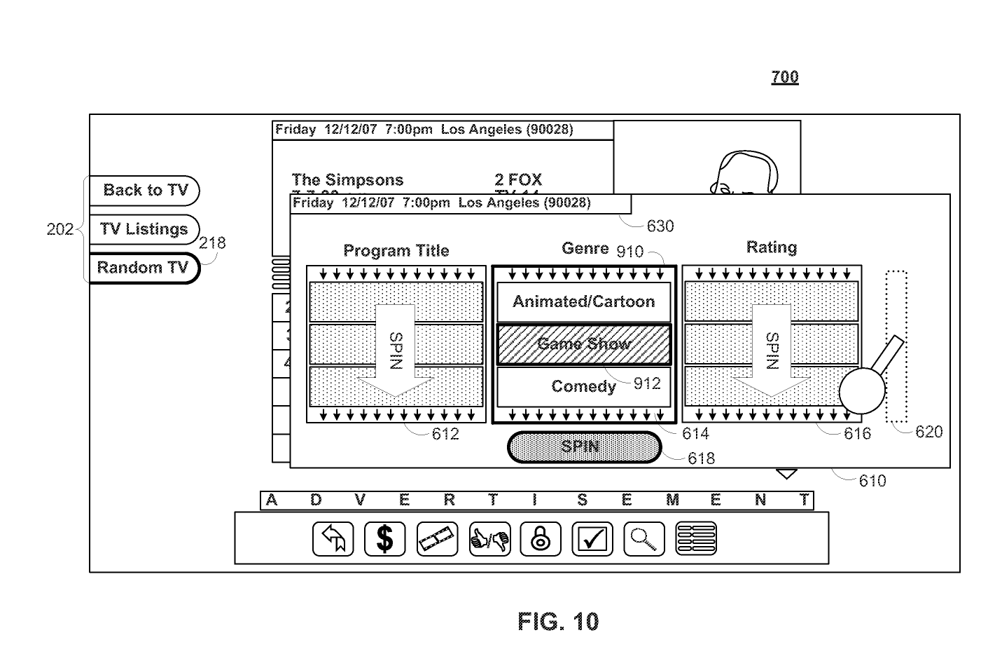

In some embodiments, control circuitry 304 may allow the user to select particular media parameters prior to randomly selecting a media guidance application listing. FIG. 9 shows an illustrative display 900 for selecting media parameters in slot machine animation 610 in accordance with some embodiments of the invention. To modify media parameters, the user may navigate through drums 612, 614, and 616 using a remote control (e.g., pressing directional arrow keys), using a finger or a stylus on a touchpad, etc. As shown in FIG. 9, the user has selected drum 614, which is indicated by a highlight region 910. In addition, the user has selected to view media in the game show category by placing a cursor 912 over the corresponding cell within drum 614 and selecting the “game show” cell.

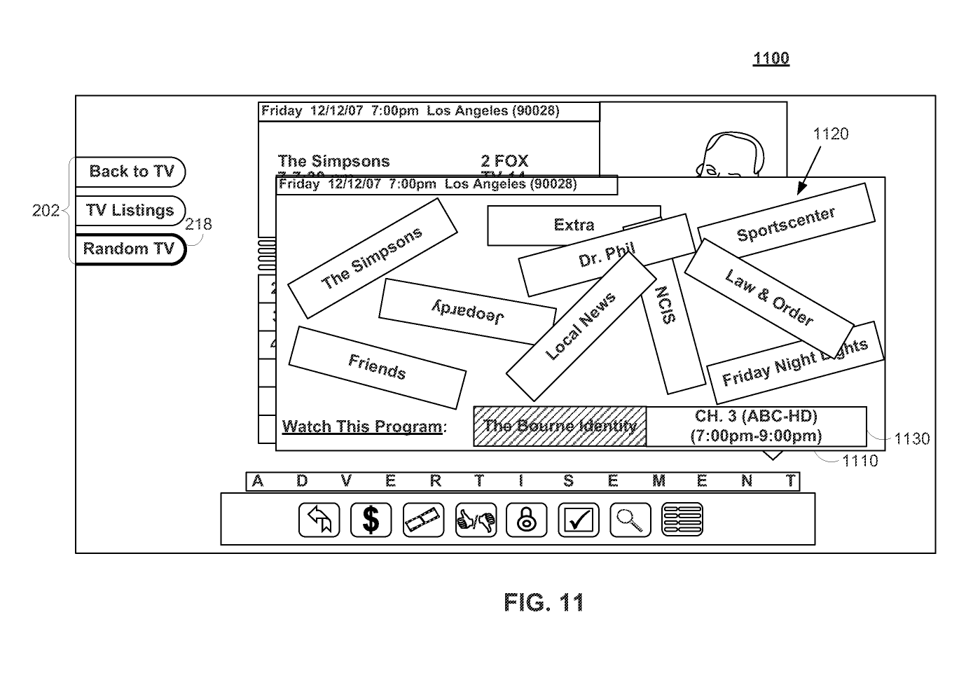

In response to selecting the game show category within drum 614, the user has indicated a desire to watch media in the game show category. As such, control circuitry 304 filters through the available media guidance application listings and populates slot machine animation 610 with the filtered listings. For example, as shown in FIG. 9, in response to selecting the game show genre, control circuitry 304 has populated slot machine animation 610 with at least the programs “Millionaire,” “Jeopardy,” and “Deal or No Deal” in drum 612 and their corresponding ratings in drum 616. Turning to FIG. 10, in response to receiving one or more signals indicative of motion of a user input device, control circuitry 304 may cause drums 612 and 616 in slot machine animation 610 to rotate, but cause drum 614 to remain stationary.

It should be noted that, in some embodiments, control circuitry 304 may allow the user to lock or define any suitable category of interest. For example, the user may provide a selection of the program title “The Simpsons.” In response to selecting a particular program title, control circuitry 304 may retrieve available categories and associated content information for placement in slot machine animation 610. More particularly, the associated rating information and genre information may be the same for each of the program listings relating to “The Simpsons.” As such, control circuitry 304 may retrieve original air date information, channel information, etc. Upon selecting the program title “The Simpsons,” control circuitry 304 may provide an animation that assists the user in selecting from multiple episodes of “The Simpsons” that are currently available (e.g., watch an episode of “The Simpsons” currently playing on Ch. 705 (FOX)).

For slot machine animation 610, control circuitry 304 may provide the user with additional options, such as, for example, adding or removing a drum of media identifiers to slot machine animation 610. In particular, control circuitry 304 may receive an indication from the user to add a drum of media identifiers relating to content type. In response, control circuitry 304 may retrieve from memory content type media identifiers associated with the available media guidance application listings and re-render slot machine animation 610 to add the additional drum. In another example, control circuitry 304 may receive an indication from the user to remove a drum of media identifiers relating to content type. In response, control circuitry 304 may re-render slot machine animation 610 to remove the indicated drum.

In some embodiments, control circuitry 304 may provide the user with an opportunity to select from a plurality of drums of media identifiers for insertion into slot machine animation 610. For example, in response to receiving one or more signals indicative of motion of a user input device, control circuitry 304 may prompt the user to select from various categories of media identifiers. In particular, control circuitry 304 may transmit a query for categories to content source 416 (FIG. 4), media guidance data source 418 (FIG. 4), or any other suitable database to retrieve a list of categories for selecting drums in slot machine animation 610. For example, control circuitry 304 may receive a list of categories that includes program titles, program duration, channel, rating, content type, and genre. In response to receiving the list of categories, control circuitry 304 may provide the user with a prompt populated with the received list of categories, where the prompt requests that the user select one or more categories from the list. Alternatively, control circuitry 304 may filter the received list of categories based on user history information, user profile information, etc. Upon receiving selected categories from the prompt, control circuitry 304 may render slot machine animation 610 with the drums corresponding to the selected categories.

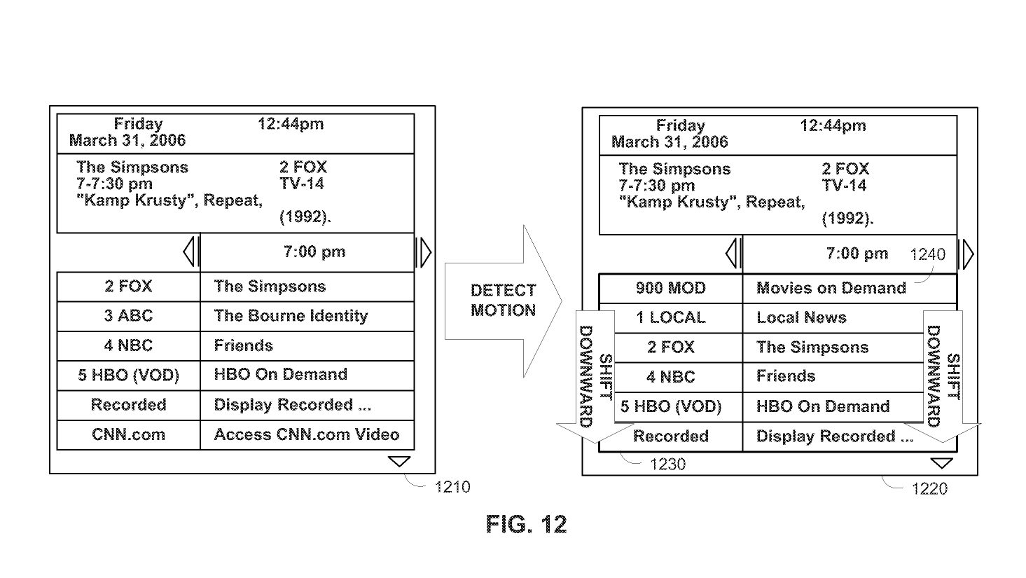

Additionally or alternatively, control circuitry 304 may provide the user with a shuffled listing animation. FIG. 11 shows an illustrative display 1100 for providing a shuffled listing animation 1110 to the user for randomly selecting a media guidance application listing in accordance with some embodiments of the invention. As shown, in response to receiving one or more signals indicative of motion of a user input device, control circuitry 304 may activate shuffled listing animation 1110, where media guidance application listings or other media identifiers shuffle, rotate, tumble, or perform any other suitable movement within animation region 1120. Upon providing shuffled listing animation 1110, control circuitry 304 may randomly select a media guidance application listing to present to the user. For example, in FIG. 11, control circuitry 304 has selected the program “The Bourne Identity,” which is showing on Ch. 3 (ABC-HD) from 7:00 PM-9:00 PM.

It should be noted that control circuitry 304 may randomly select media guidance application listing 1130 using any suitable approach. For example, control circuitry 304 may cause each of the media identifiers to tumble at randomly selected rates within region 1120 and may determine which of the media identifiers is first to reach the bottom of region 1120. In another example, control circuitry 304 may select media guidance application listing 1130 based on user history information, user preference information, or user profile information and cause media identifier 1130 to reach the bottom of region 1120 first in shuffled listing animation 1110.

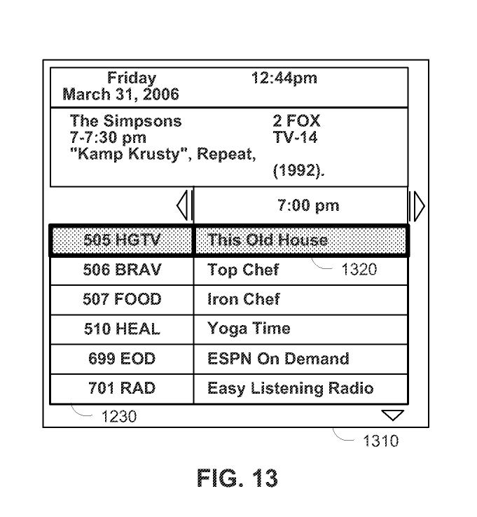

Additionally or alternatively, control circuitry 304 may animate the media guidance application listings displayed in, for example, grid 102 of FIG. 1 or mosaic display 200 of FIG. 2. FIGS. 12 and 13 show illustrative displays for animating a presented media guidance application display in accordance with some embodiments of the invention.

For example, as shown in FIG. 12, a browse display 1210 may be displayed for the user when control circuitry 304 receives an instruction from the user via user input interface. In particular, the user may press a GUIDE button on a remote control or select a listings option using the user's finger on a touchscreen. Referring back to FIG. 1, in some embodiments, browse display 1210 and its media guidance application listings may be displayed simultaneously or together with a video.

In response to receiving one or more signals indicative of motion of a user input device, control circuitry 304 may cause a region 1230 within browse display 1210 to be animated. For example, as shown in browse display 1220 of FIG. 12, region 1230 is animated by shifting the media guidance application listings in a downward motion. In particular, a preceding listing 1240 (e.g., “Movies on Demand” on Ch. 900 (MOD)) that is currently not displayed in browse display 1210 is newly displayed in the top row of browse display 1220 and the remainder of the listings are shifted downwards. Control circuitry 304 may cause the animation within region 1230 to execute for a predetermined amount of time (e.g., five seconds) or until a media guidance application listing has been selected by control circuitry 304.

As shown in FIG. 13, control circuitry 304 may provide the user with the randomly selected media guidance application listing. For example, control circuitry 304 may place a highlight region 1320 over the randomly selected media guidance application listing (e.g., “This Old House” on Ch. 505 (HGTV)). In response to selecting the randomly selected media guidance application listing by pressing a select button on the remote control or selecting the listing using a touch screen, control circuitry 304 may present the content corresponding to the media guidance application listing.

Additionally or alternatively to presenting the content corresponding to the selected listing (e.g., by tuning to the channel), control circuitry 304 may provide the user with the opportunity to set various settings, such as record the content, set a reminder to watch the content, etc. In some embodiments, control circuitry 304 may select the media guidance application listing and instruct a second screen device (e.g., wireless user communications device 406) to tune to the content, record the content, set a reminder to watch the content, etc. In some embodiments, control circuitry 304 may select the media guidance application listing on a first user equipment device and instruct control circuitry 304 to instruct the second screen device to tune to the content and simultaneously record the content in a storage device connected to the first user equipment device.

Although control circuitry 304 is generally described as providing the user with one animation (e.g., slot machine animation in FIG. 6, shuffling listing animation in FIG. 11, or browse listing animation in FIG. 12), this is merely illustrative. Any suitable number of animations may be provided to the user. For example, in response to the user selecting a random selection option, control circuitry 304 may select from one of multiple animations for providing to the user. In another example, control circuitry 304 may prompt the user to select from multiple animations that randomly select media guidance application listings for the user. In yet another example, control circuitry 304 may select an animation from multiple animations based on the received motion information (e.g., based on the gesture from the user).

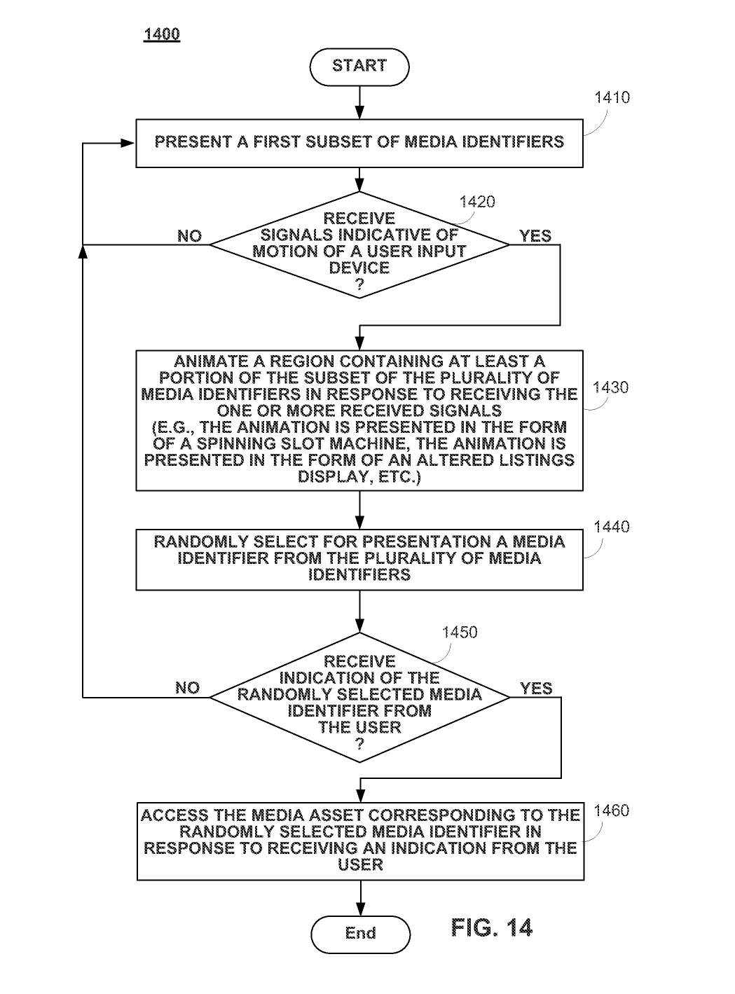

FIG. 14 illustrates a flow diagram 1400 for randomly selecting a media guidance application listing for the user in accordance with some embodiments of the invention.

At step 1410, a first subset of media identifiers is presented. For example, a user may navigate through a browse display, such as grid 102 of FIG. 1, and select a random selection option, such as option 218 of FIG. 2. In response, control circuitry 304 may retrieve a plurality of media identifiers relating to available media and provide the user with an animation that has been populated with the first subset of media identifiers. For example, control circuitry 304 may retrieve media identifiers and insert them into a first image of an animation, such as slot machine animation 610 of FIG. 6.

At step 1420, control circuitry 304 may determine whether signals indicative of motion of a user input device have been received. For example, control circuitry 304 may receive motion and/or orientation information from user input interface 310 having accelerometer 316 or user sensor 318 that is integrated into user equipment 300. Alternatively, a wireless user communications device 406 (e.g., a mobile phone or a portable video player) may have an accelerometer for detecting motion information relating to wireless user communications device 406 and may communicate with user television equipment 402, which is executing the media guidance application. In response, wireless user communications device 406 may transmit at least a portion of the motion information to user television equipment 402.

In response to receiving or detecting signals indicative of motion of the user input device, control circuitry 304 may animate a region containing at least a portion of the first subset of media identifiers at step 1430. For example, as shown in slot machine animation 610 of FIGS. 6-10, each drum of media identifiers may be animated by spinning or rotating the drum for a predetermined amount of time. In another example, as shown in shuffled listing animation 1110 of FIG. 11, region 1120 may be animated by shuffling program listings. In yet another example, as shown in browse display 1220 of FIG. 12, portions of a browse display, such as a grid of program listings in region 1230, may be animated by shifting the program listings downward.

Any suitable mechanism may be used for presenting a display having one or more animations for selecting and/or recommending a media identifier. For example, in some embodiments, control circuitry 304 may receive one or more signals indicative of motion of a user input device and/or receive an indication to randomly select a media guidance application listing. In response, control circuitry 304 may transmit a query transmit a query to content source 416 (FIG. 4), media guidance data source 418 (FIG. 4), or any other suitable database to retrieve one or more animations and their associated properties. In particular, control circuitry 304 may retrieve from the data source or database one or more animation files and content data for populating the one or more animation files. For example, control circuitry 304 may receive a slot machine animation file having three rotatable drums and the associated media identifiers for populating into those drums. In another example, control circuitry 304 may retrieve the animation file and a plurality of media identifiers, where control circuitry 304 filters the media identifiers based on user history information before inserting them into the animation file.

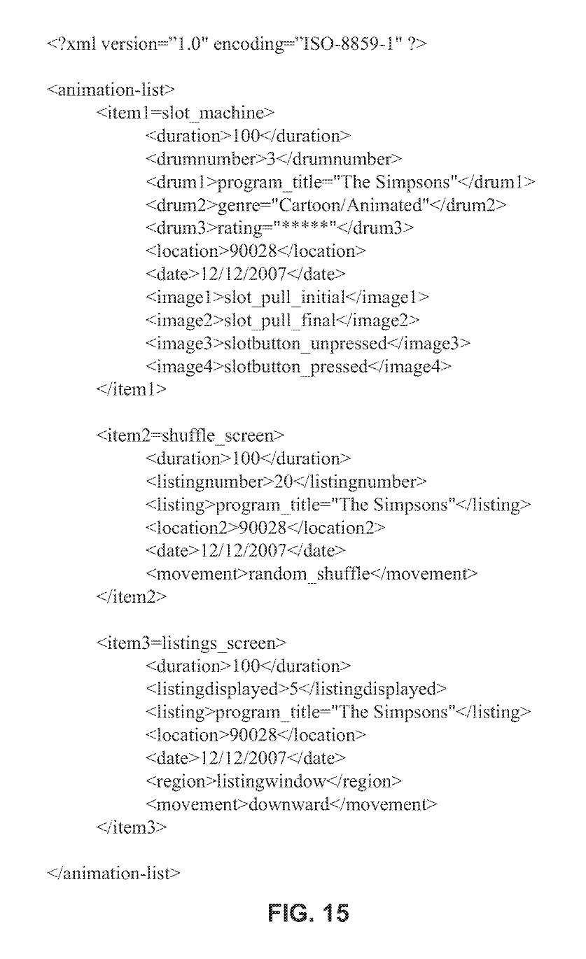

In response, an animation file may be loaded, where an initial image in a sequence of images is displayed. Control circuitry 304 may insert program titles (e.g., “The Simpsons”), genre (e.g., “Cartoon/Animated”), and rating information (e.g. *****) from storage using the XML structures illustrated in FIG. 15 for insertion into the initial image and other images in the animation. In response to setting media parameters, control circuitry 304 may update the animation by retrieving additional program titles, genre information, rating information, or other media identifiers using the XML structures illustrated in FIG. 15.

At step 1440, control circuitry 304 may randomly select a media identifier for presentation to the user. For example, upon presenting the animation, control circuitry 304 may randomly select a media guidance application listing (e.g., “The Simpsons” on Ch. 2) to recommend to the user. In another example, upon presenting the animation, control circuitry 304 may randomly select a plurality of media identifiers, such as the genre “sports” and the timeslot “7:00 pm,” and control circuitry may use the randomly selected media identifiers to determine a recommended media guidance application listing, such as “ESPN News” on Ch. 28.

It should be noted that, while control circuitry 304 may randomly select a media identifier from a plurality of media identifiers, this is merely illustrative. As described herein, the selection may be a random selection from multiple media identifiers, a pseudo-random selection from multiple media identifiers, a selection from multiple media identifiers based on filtered media identifiers, a selection from multiple media identifiers based on location information, a selection from multiple media identifiers based on user history information, etc.

In some embodiments, control circuitry 304 may transmit a query to content source 416 (FIG. 4), media guidance data source 418 (FIG. 4), or any other suitable database to retrieve a randomly selected media identifier from a plurality of media identifiers. For example, the query may include the plurality of media identifiers and, in response to the query, control circuitry 304 may receive a selected media identifier.

At step 1450, control circuitry 304 may determine whether the user has indicated to access the media asset or program corresponding to the selected media identifier. For example, the user may press a select button on the remote control to select the presented media identifier. In response, control circuitry 304 may access the corresponding media asset at 1460. For example, control circuitry 304 may tune to the channel providing the program corresponding to the selected media identifier. In another example, control circuitry 304 may display the media asset in a preview window. Additionally or alternatively to presenting the content corresponding to the selected media identifier, control circuitry 304 may provide the user with the opportunity to set various settings, such as record the content, set a reminder to watch the content, etc. In some embodiments, control circuitry 304 may select the media guidance application listing and instruct a second screen device (e.g., wireless user communications device 406) to tune to the content, record the content, set a reminder to watch the content, etc.

Otherwise, if the user does not select the recommended media asset, control circuitry 304 may allow the user to request another recommendation (e.g., by shaking the user input device again), may return the user back to the first image of the animation at step 1410 to modify media parameters, and/or return the user to browse through listings in grid 102 (FIG. 1).

It should be understood that the above steps of the flow diagram of FIG. 14 may be executed or performed in any order or sequence not limited to the order and sequence shown and described in the figure. Also, some of the above steps of the flow diagram of FIG. 14 may be executed or performed substantially simultaneously where appropriate or in parallel to reduce latency and processing times.

The above described embodiments of the present disclosure are presented for purposes of illustration and not of limitation, and the present disclosure is limited only by the claims which follow.

What is claimed is:

1. A method for recommending media in an interactive media guidance application, the method comprising:
storing a plurality of media identifiers;
causing a subset of the plurality of media identifiers to be presented to a user;
receiving one or more signals indicative of motion of a user input device of the user;
animating a region containing at least a portion of the subset of the plurality of media identifiers in response to receiving the one or more received signals; and
randomly selecting for presentation to the user a media identifier from the plurality of media identifiers.

2. The method of claim 1, wherein the one or more signals indicative of motion of the user input device are received from an accelerometer in the user input device.

3. The method of claim 1, wherein the region is a graphical representation of a slot machine having a plurality of rotatable drums and wherein one or more media identifiers are placed on each of the plurality of rotatable drums.

4. The method of claim 3, further comprising causing the user equipment device to access the randomly selected media identifier in response to receiving an indication from the user on the user input device.

5. The method of claim 1, wherein each of the plurality of media identifiers is defined by a plurality of media parameters.

6. The method of claim 5, further comprising:
receiving at least one defined media parameter from the user; and
filtering the plurality of media identifiers in response to receiving the at least one defined media parameter from the user.

7. The method of claim 5, wherein each of the plurality of media identifiers is animated based on the plurality of media parameters.

8. The method of claim 1, further comprising receiving location information from the user input device, wherein the media identifier is selected from the plurality of media identifiers based at least in part on the one or more received signals and the location information.

9. The method of claim 1, wherein each of the plurality of media identifiers is animated for a period of time based on signal duration information derived from the one or more received signals.

10. The method of claim 1, further comprising causing a program corresponding to the randomly selected media identifier to be displayed in response to receiving an indication from the user.

11. A system for recommending media in an interactive media guidance application, the system comprising:
a storage device;
processing circuitry configured to:
store a plurality of media identifiers in the storage device;
cause a subset of the plurality of media identifiers to be presented to a user;
receive one or more signals indicative of motion of a user input device of the user;
animate a region containing at least a portion of the subset of the plurality of media identifiers in response to receiving the one or more received signals; and
randomly select for presentation to the user a media identifier from the plurality of media identifiers.

12. The system of claim 11, wherein the one or more signals indicative of motion of the user input device are received from an accelerometer in the user input device.

13. The system of claim 11, wherein the region is a graphical representation of a slot machine having a plurality of rotatable drums and wherein one or more media identifiers are placed on each of the plurality of rotatable drums.

14. The system of claim 13, wherein the processing circuitry is further configured to cause the user equipment device to access the randomly selected media identifier in response to receiving an indication from the user on the user input device.

15. The system of claim 11, wherein each of the plurality of media identifiers is defined by a plurality of media parameters.

16. The system of claim 15, wherein the processing circuitry is further configured to:
receive at least one defined media parameter from the user; and
filter the plurality of media identifiers in response to receiving the at least one defined media parameter from the user.

17. The system of claim 15, wherein each of the plurality of media identifiers is animated based on the plurality of media parameters.

18. The system of claim 11, wherein the processing circuitry is further configured to receive location information from the user input device, wherein the media identifier is selected from the plurality of media identifiers based at least in part on the one or more received signals and the location information.

19. The system of claim 11, wherein each of the plurality of media identifiers is animated for a period of time based on signal duration information derived from the one or more received signals.

20. The system of claim 11, wherein the processing circuitry is further configured to cause a program corresponding to the randomly selected media identifier to be displayed in response to receiving an indication from the user.

21-30. (canceled)
